(19) United States
(12) Patent Application Publication
(10) Pub. No.: US 2025/0261141 A1
(43) Pub. Date: Aug. 14, 2025

(54) AMBIENT INTERNET-OF-THINGS QUERYING

(71) Applicant: QUALCOMM Incorporated, San Diego, CA (US)

(72) Inventors: Piyush GUPTA, Bridgewater, NJ (US); Le LIU, San Jose, CA (US); Umesh PHUYAL, San Diego, CA (US); Chengjin ZHANG, San Diego, CA (US); Yuchul KIM, San Diego, CA (US); Junyi LI, Greentown, PA (US); Raviteja PATCHAVA, San Diego, CA (US)

(21) Appl. No.: 19/034,129

(22) Filed: Jan. 22, 2025

Related U.S. Application Data
(60) Provisional application No. 63/553,272, filed on Feb. 14, 2024.

(51) Int. Cl. H04W 56/00; H04L 1/08

(52) U.S. Cl. CPC H04W 56/001; H04L 1/08

(57) ABSTRACT

Various aspects of the present disclosure generally relate to wireless communication. In some aspects, an ambient Internet-of-Things (IoT) device may receive, from a reader, one or more first messages during a wakeup period, wherein a first message, of the one or more first messages, includes a plurality of elements, and wherein the plurality of elements includes a synchronization signal and an identifier. The ambient IoT device may transmit, to the reader, a second message as a response to the one or more first messages. Numerous other aspects are described.

### CROSS-REFERENCE TO RELATED APPLICATION

This Patent application claims priority to U.S. Provisional Patent Application No. 63/553,272, filed on Feb. 14, 2024, entitled “AMBIENT INTERNET-OF-THINGS QUERYING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for ambient internet-of-things (IoT) querying.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by an ambient Internet-of-Things (IoT) device. The method may include receiving, from a reader, one or more first messages during a wakeup period, where a first message, of the one or more first messages, includes a plurality of elements, where the plurality of elements includes a synchronization signal and an identifier. The method may include transmitting, to the reader, a second message as a response to the one or more first messages.

Some aspects described herein relate to a method of wireless communication performed by a reader. The method may include transmitting, to an ambient IoT device, one or more first messages during a wakeup period, where a first message, of the one or more first messages, includes a plurality of elements, where the plurality of elements includes a synchronization signal and an identifier. The method may include receiving, from the ambient IoT device, a second message as a response to the one or more first messages.

Some aspects described herein relate to a non-transitory computer-readable medium that stores a set of instructions for wireless communication by one or more processors of an ambient IoT device. The set of instructions, when executed by one or more processors of an ambient IoT device, may cause the ambient IoT device to receive, from a reader, one or more first messages during a wakeup period, where a first message, of the one or more first messages, includes a plurality of elements, where the plurality of elements includes a synchronization signal and an identifier. The set of instructions, when executed by one or more processors of an ambient IoT device, may cause the ambient IoT device to transmit, to the reader, a second message as a response to the one or more first messages.

Some aspects described herein relate to a non-transitory computer-readable medium that stores a set of instructions for wireless communication by a reader. The set of instructions, when executed by one or more processors of the reader, may cause the reader to transmit, to an ambient IoT device, one or more first messages during a wakeup period, where a first message, of the one or more first messages, includes a plurality of elements, where the plurality of elements includes a synchronization signal and an identifier. The set of instructions, when executed by one or more processors of the reader, may cause the reader to receive, from the ambient IoT device, a second message as a response to the one or more first messages.

Some aspects described herein relate to an ambient IoT device for wireless communication. The ambient IoT device may include one or more memories and one or more processors coupled to the one or more memories. The one or more processors may be configured to receive, from a reader, one or more first messages during a wakeup period, where a first message, of the one or more first messages, includes a plurality of elements, where the plurality of elements includes a synchronization signal and an identifier. The one or more processors may be configured to transmit, to the reader, a second message as a response to the one or more first messages.

Some aspects described herein relate to a reader for wireless communication. The reader may include one or more memories and one or more processors coupled to the one or more memories. The one or more processors may be configured to transmit, to an ambient IoT device, one or more first messages during a wakeup period, where a first message, of the one or more first messages, includes a plurality of elements, where the plurality of elements includes a synchronization signal and an identifier. The one or more processors may be configured to receive, from the ambient IoT device, a second message as a response to the one or more first messages.

Some aspects described herein relate to an apparatus for wireless communication. The apparatus may include means for receiving, from a reader, one or more first messages during a wakeup period, where a first message, of the one or more first messages, includes a plurality of elements, where the plurality of elements includes a synchronization signal and an identifier. The apparatus may include means for transmitting, to the reader, a second message as a response to the one or more first messages.

Some aspects described herein relate to an apparatus for wireless communication. The apparatus may include means for transmitting, to an ambient IoT device, one or more first messages during a wakeup period, where a first message, of the one or more first messages, includes a plurality of elements, where the plurality of elements includes a synchronization signal and an identifier. The apparatus may include means for receiving, from the ambient IoT device, a second message as a response to the one or more first messages.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example associated with backscatter communications, in accordance with the present disclosure.

FIG. 5 is a diagram illustrating an example of a timing for ambient Internet-of-Things (IoT) querying, in accordance with the present disclosure.

FIG. 6 is a diagram illustrating an example associated with inventory querying, in accordance with the present disclosure.

FIG. 7 is a diagram illustrating an example associated with command querying, in accordance with the present disclosure.

FIG. 8 is a diagram illustrating an example process performed, for example, at an ambient IoT device or an apparatus of an ambient IoT device, in accordance with the present disclosure.

FIG. 9 is a diagram illustrating an example process performed, for example, at a reader or an apparatus of a reader, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Ambient Internet-of-Things (IoT) devices, which may be a type of user equipment (UE) or another type of network device, may include devices that have less processing capability for decoding signals than other types of UEs. Some ambient IoT devices may lack battery power or some radio frequency (RF) components, such as a local oscillator. An ambient IoT device may detect an amplitude shift keying (ASK) or a phase shift keying (PSK) modulated signal transmitted by a reader, which may be a type of UE or a type of network node, that transmits signals to and receives signals from ambient IoT devices. In one use case, ambient IoT devices may be used as tags for inventory tracking, such as within a warehouse or factory environment, and a reader may be used to periodically perform an inventory of items by reading available ambient IoT devices. During inventorying, a reader may query a tag and the tag may report information associated with the tag, such as a device identifier or a position identifier. In another use case, ambient IoT devices may be used as control devices, such as within a grocery store or as a controller of a smart agriculture system. When used as control devices, a reader may query a tag and provide a command, and the tag may transmit an acknowledgment that the command has been received. For example, the reader may transmit a command to change a price on a smart price tag or a command to activate or deactivate a smart agriculture device.

Some operating environments may have thousands or even millions of tags with hundreds or thousands of readers to read the tags. Such use cases may perform periodic or on-demand inventorying (e.g., tag reading) and may have strict latency requirements (e.g., on an order of one to several seconds) for completing inventorying or command transmission and acknowledgment. However, to conserve energy resources, a tag may enter a sleep mode, which may conserve energy, but prevent the tag from receiving an inventory query or a command query. Accordingly, a reader may use an unsynchronized duty-cycle based wake-up operation at tags. In this example, the reader may transmit a plurality of queries during an inventory or command instance to allow tags waking-up at different times to receive at least one query. In other words, when the tag is configured to wake up every X seconds and stay awake for a period of Y seconds, the reader may transmit queries with a periodicity of Z seconds (where X>Y>Z), such that each tag will receive at least one query during the awake period of the tag.

However, some reduced capability UEs, such as ambient IoT devices (e.g., tags) may lack control information for completing a query procedure with a reader. For example, the low latency requirement associated with a query procedure, such as inventory querying or command querying, may prevent use of channel access procedures that provide an ambient IoT device with resources to receive information from or transmit information to a reader. Accordingly, it is desirable for a query procedure to have a self-contained set of messages that provide the information that a tag uses for completing a query procedure.

Various aspects relate generally to providing query procedures for inventory querying and/or command querying. For example, an ambient IoT device may receive a first message that includes a synchronization signal and a query. The query may include selection criteria identifying a subset of ambient IoT devices to which the first message is applicable, such as ambient IoT devices of a particular type or ambient IoT devices assigned a device identifier or group identifier. The ambient IoT device may transmit a second message, which may include a tag response message indicating that the ambient IoT device received the first message, has synchronized using the synchronization signal of the first message, and is ready to receive an inventory query or a command query. In this case, the ambient IoT device and the reader may communicate using one or more messages (e.g., a third message, a fourth message, a fifth message, or a sixth message, as described in more detail herein) to complete the query procedure. For example, the ambient IoT device may receive a request for tag data (e.g., in an inventory querying procedure) or may receive a command (e.g., in a command querying procedure) and may transmit the tag data or transmit an acknowledgment of the command, respectively.

Particular aspects of the subject matter described in this disclosure can be implemented to realize one or more of the following potential advantages. In some examples, by including a synchronization signal in the first message, the described techniques can be used to enable an ambient IoT device to respond to a query without completing resource intensive channel access procedures. Additionally, or alternatively, by using multiplexing for tag response messages, the ambient IoT device may reduce contention with other ambient IoT devices responding within a dense device environment (e.g., an environment with many devices operating). Similarly, the reader may transmit information identifying a resource allocation with frequency shifting or sequence shifting to avoid contention in communication with the ambient IoT devices. By reducing or avoiding contention, the reader and the ambient IoT device may reduce dropped communications, thereby improving performance, and may reduce network resource utilization associated with retransmitting dropped communications.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

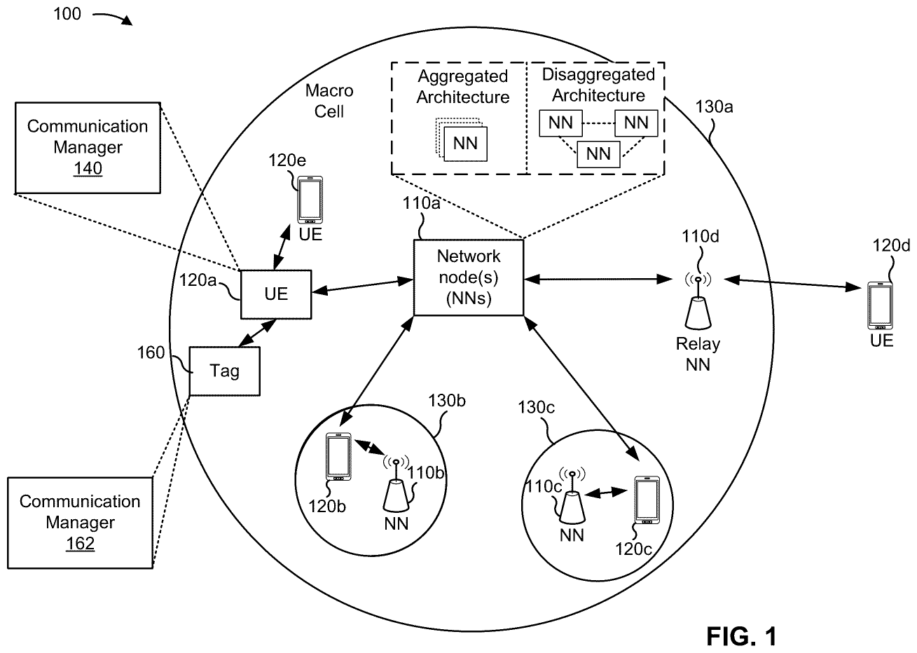

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some examples, a UE 120, such as the UE 120a, may be a reader that communicates with an ambient Internet-of-Things (IoT) device, such as the tag 160. For example, the UE 120a may transmit a query message to the tag 160, which may transmit a query response to the UE 120a. In other examples, a network node 110 may be a reader that communicates with an ambient IoT device, such as the tag 160. Accordingly, although some aspects are described herein in terms of a UE-type of reader, it is contemplated that aspects described herein may use a network node-type of reader.

In some aspects, an ambient IoT device (e.g., the tag 160) may include a communication manager 162. As described in more detail elsewhere herein, the communication manager 162 may receive, from a reader, one or more first messages during a wakeup period, wherein a first message, of the one or more first messages, includes a plurality of elements, wherein the plurality of elements includes a synchronization signal and an identifier; and transmit, to the reader, a second message as a response to the one or more first messages. Additionally, or alternatively, the communication manager 162 may perform one or more other operations described herein.

In some aspects, a reader (e.g., the UE 120) may include a communication manager 140. As described in more detail elsewhere herein, the communication manager 140 may transmit, to an ambient Internet-of-Things (IoT) device, one or more first messages during a wakeup period, wherein a first message, of the one or more first messages, includes a plurality of elements, wherein the plurality of elements includes a synchronization signal and an identifier; and receive, from the ambient IoT device, a second message as a response to the one or more first messages. Additionally, or alternatively, the communication manager 140 may perform one or more other operations described herein.

As indicated above, FIG. 1 is provided as an example. Other examples may differ from what is described with regard to FIG. 1.

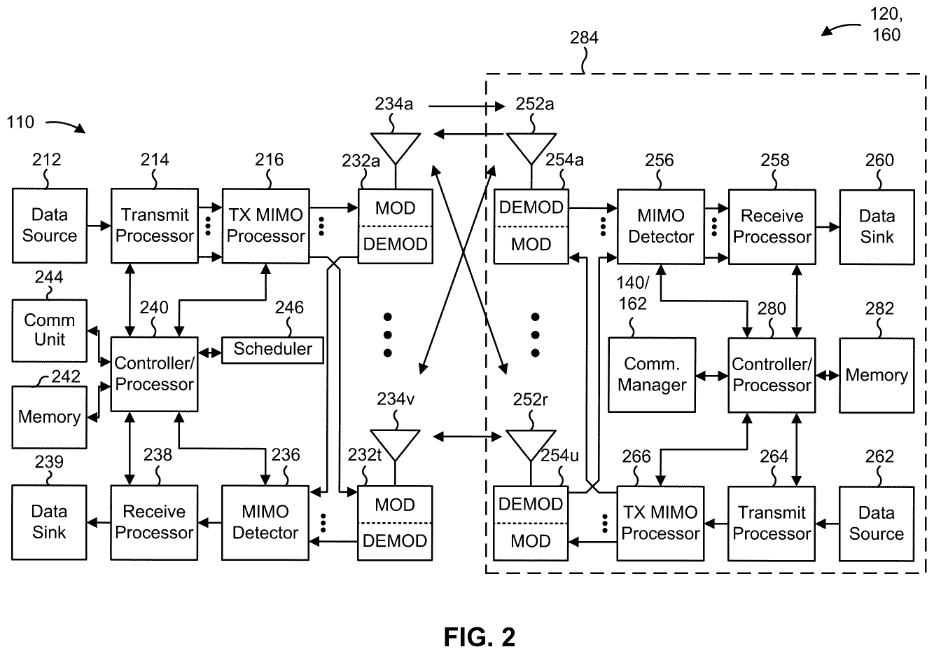

FIG. 2 is a diagram illustrating an example network node 110 in communication with an example UE 120 in a wireless network in accordance with the present disclosure. In some examples, the UE 120 may be in communication with a tag 160.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110 (or from a tag 160 to a UE 120), uplink signals from the UE 120 (or tag 160) may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Although some examples are described in terms of a UE 120 in communication with a network node 110 on an uplink and a downlink, the UE 120 may be in communication with a tag 160 on an uplink and a downlink. For example, a tag 160 may transmit on an uplink to the UE 120 and may receive on a downlink from the UE 120. Additionally, or alternatively, although some components are described in terms of a UE 120, a tag 160 may include the same or similar components, such as a communication manager 162, a controller/processor 280, an antenna 252, a memory 282, or a data source 262, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

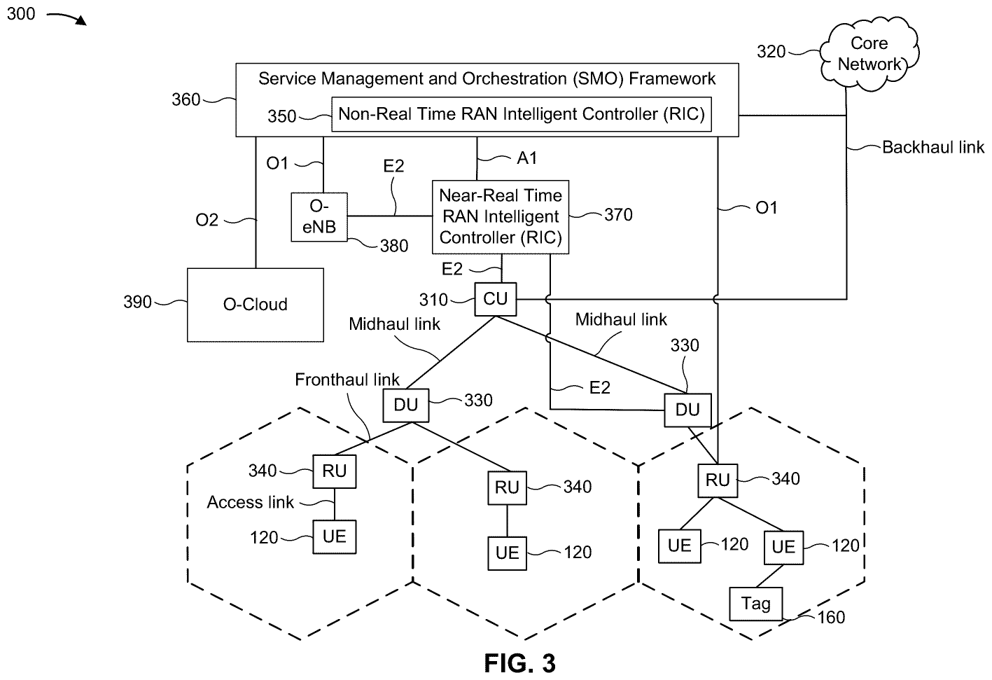

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340. The UE 120 may serve a group of tags 160.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some examples, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

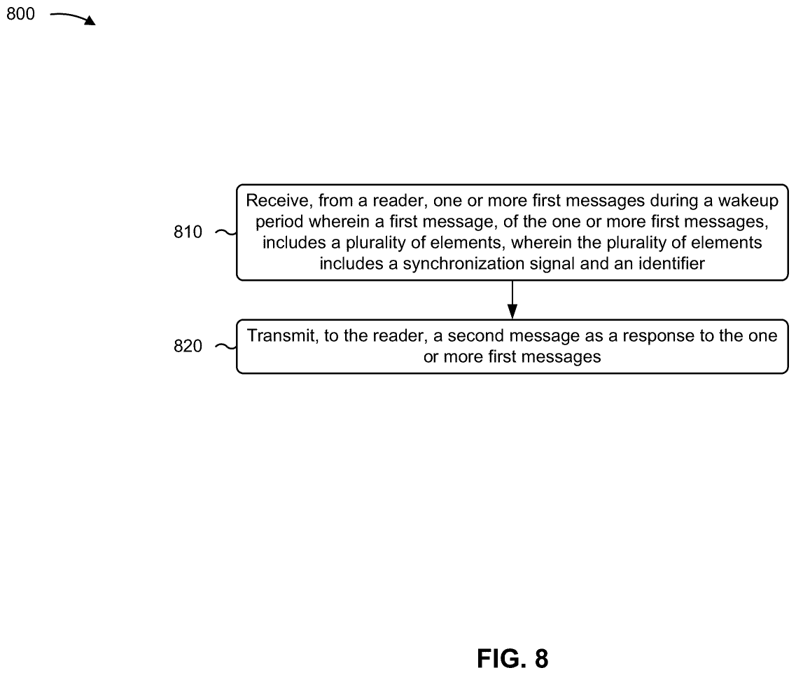

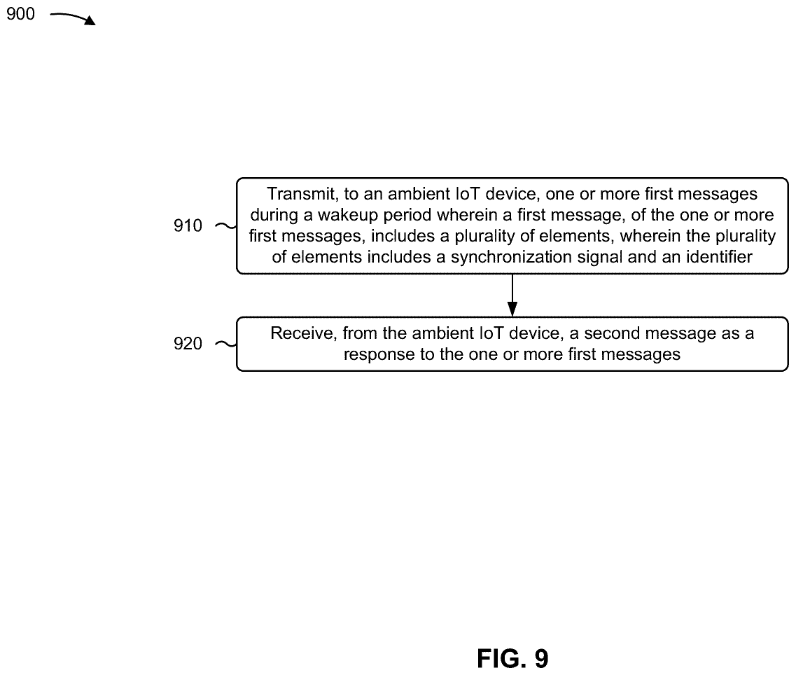

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with ambient Internet-of-Things (IoT) querying, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, an ambient IoT device, such as a tag 160, includes means for receiving, from a reader, one or more first messages during a wakeup period, wherein a first message, of the one or more first messages, includes a plurality of elements, wherein the plurality of elements includes a synchronization signal and an identifier; and/or means for transmitting, to the reader, a second message as a response to the one or more first messages. In some aspects, the means for the ambient IoT device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a reader, such as the UE 120, includes means for transmitting, to an ambient IoT device, one or more first messages during a wakeup period, wherein a first message, of the one or more first messages, includes a plurality of elements, wherein the plurality of elements includes a synchronization signal and an identifier; and/or means for receiving, from the ambient IoT device, a second message as a response to the one or more first messages. In some aspects, the means for the reader to perform operations described herein may include, for example, one or more of communication manager 140, antenna 252, modem 254, MIMO detector 256, receive processor 258, transmit processor 264, TX MIMO processor 266, controller/processor 280, or memory 282. Although some aspects describe the reader in terms of a UE 120, it is contemplated that the reader may be a network node 110 (and the tag 160 may be a UE 120).

As indicated above, FIG. 3 is provided as an example. Other examples may differ from what is described with regard to FIG. 3.

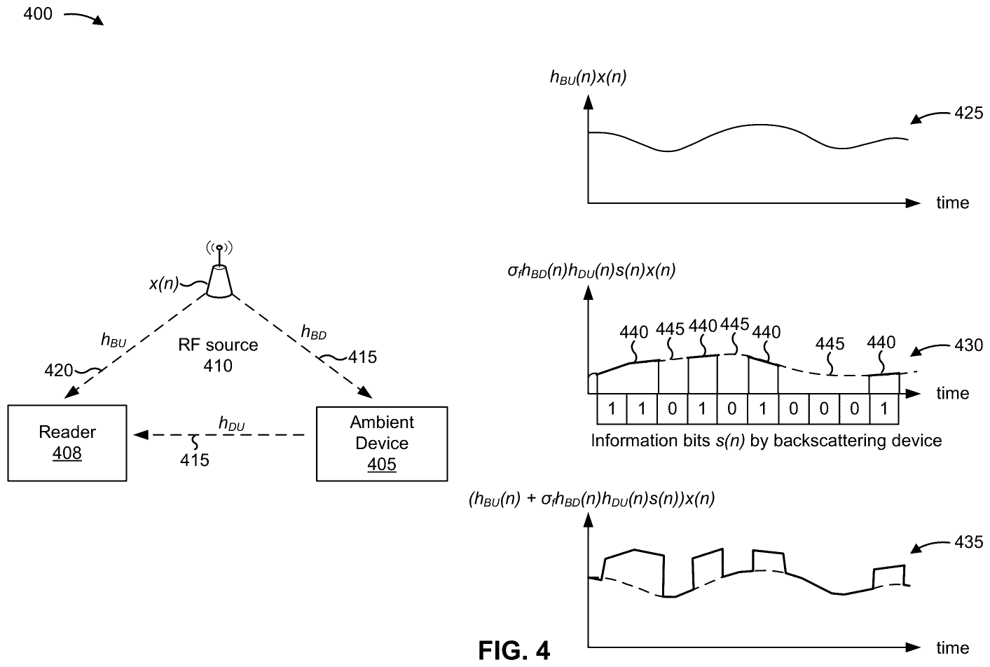

FIG. 4 is a diagram illustrating an example 400 associated with backscatter communications, in accordance with the present disclosure.

Some wireless communication devices may be considered IoT devices, such as ambient IoT devices (sometimes referred to as “tags”), or similar IoT devices. IoT technology may include passive IoT (e.g., NR passive IoT for 5G Advanced), semi-passive IoT, ultra-light IoT, or ambient IoT, among other examples. In passive IoT, a terminal (e.g., a radio frequency identification (RFID) device, a tag, or a similar device) may not include a battery, and the terminal may accumulate energy from radio signaling. Additionally, the terminal may accumulate solar energy to supplement accumulated energy from radio signaling. In passive IoT, a communication distance may be up to 30 meters (or more) to facilitate feasible network coverage over a large area (e.g., 5000 square meters), such as in a warehouse. Moreover, the power consumption of a passive IoT terminal (e.g., a tag) may be less than 0.1 milliwatts (mW) to support operation without a battery, and the terminal may be relatively inexpensive to facilitate cost-sensitive uses. A positioning accuracy of a passive IoT terminal may be approximately 2-5 meters in the horizontal and the vertical directions.

Passive IoT may be useful in connection with industrial sensors, for which battery replacement may be prohibitively difficult or undesirable (e.g., for safety monitoring or fault detection in smart factories, infrastructures, or environments). Additionally, features of passive IoT devices, such as low cost, small size, maintenance-free, durable, long lifespan, or the like, may facilitate smart logistics/warehousing (e.g., in connection with automated asset management by replacing RFID tags). Furthermore, passive IoT may be useful in connection with smart home networks for household item management, wearable devices (e.g., wearable devices for medical monitoring for which patients do not need to replace batteries), and/or environment monitoring. To achieve further cost reduction and zero-power communication, 5G+/6G wireless networks may utilize a type of passive IoT device referred to as an “ambient backscatter device” or a “backscatter device.”

In active IoT (or semi-passive IoT), a terminal (e.g., a radio frequency identification (RFID) device, a tag, or a similar device) may include a battery, but the battery may have limited resources. The terminal may be positioned too far from a reader to effectively perform energy harvesting (EH) and accumulate energy from radio signaling. Additionally, the terminal may accumulate solar energy to supplement accumulated energy from radio signaling. For example, a communication distance may be greater than 30 meters, such as in a warehouse, an airport terminal, a shipping port, a hospital, a farm, or another type of environment. Accordingly, a terminal may use a sleep mode to reduce energy consumption (e.g., relative to asynchronous operation or continuous monitoring) and operate with limited battery resources.

Active IoT (or semi-passive IoT) may be useful in connection with industrial sensors, for which battery charging is inconvenient (e.g., for large quantities of devices, for devices that are moving within a warehouse, or for devices that are located in inconvenient-to-access locations).

As shown in FIG. 4, an ambient device 405 (e.g., a tag, a sensor, or the like), which may be one example of an ambient IoT device, may employ a simplified hardware design that does not include a battery or includes a low energy storage battery, such that the ambient device 405 relies on energy harvesting for power or a sleep mode to conserve power resources. More particularly, the ambient device 405 communicates with a reader 408 (e.g., a UE 120 or a network node 110) by transmitting a radio frequency signal or reflecting a radio wave (e.g., backscattering a radio signal from an RF source 410). In some examples, the RF source 410 and the reader 408 may be the same device and/or may be co-located. For example, in some cases, the reader 408 and the RF source 410 may be associated with the same network node 110.

To facilitate backscatter communication of the ambient device 405, the RF source 410 may transmit an energy harvesting wave to the ambient device 405. The energy harvesting wave may be transmitted for a sufficient duration in order to enable a communication phase for a target range between the reader 408 and the ambient device 405. Additionally, or alternatively, in some cases, a range between the RF source 410 and the ambient device 405 may be limited by a minimum received power for triggering energy harvesting at the ambient device 405, such as −20 decibel milliwatts (dBm).

Once energy is sufficiently accumulated at the ambient device 405 (or using limited battery resources of the ambient device 405), the ambient device 405 may begin to reflect the radio wave that is radiated onto the ambient device 405 via a backscatter link 415. For example, the RF source 410 may initiate a communication session (sometimes referred to as a query-response communication session) with a query, which may be a modulating envelope of a continuous wave (CW). The ambient device 405 may respond by backscattering of the CW. The communication session may include multiple rounds, such as for purposes of contention resolution when multiple backscatter devices respond to a query. A channel between the RF source 410 and the ambient device 405 of the backscatter link 415 may be associated with a first backscatter link channel response value (sometimes referred to as a first backscatter link channel coefficient or a first backscatter link gain value), h_{BD}. The ambient device 405 may have reflection-on periods and reflection-off periods that follow a pattern that is based at least in part on the transmission of information bits by the ambient device 405. The reader 408 may detect the reflection pattern of the ambient device 405 and obtain the backscatter communication information via the backscatter link 415. A channel between the reader 408 and the ambient device 405 of the backscatter link 415 may be associated with a second backscatter link channel response value (sometimes referred to as a second backscatter link channel coefficient or a second backscatter link channel gain value), h_{DU}. In addition, the RF source 410 and the reader 408 may communicate (e.g., reference signals and/or data signals) via a direct link 420. A channel between the RF source 410 and the reader 408 of the direct link 420 may be associated with a direct link channel response value (sometimes referred to as a direct link channel coefficient or a direct link channel gain value), h_{BU}.

The ambient device 405 may use an information modulation scheme, such as amplitude shift keying (ASK) modulation or on-off keying (OOK) modulation. For ASK or OOK modulation, the ambient device 405 may switch on reflection when transmitting an information bit “1” and switch off reflection when transmitting an information bit “0.” In backscatter communication, the RF source 410 may transmit a particular radio wave (e.g., a reference signal or a data signal, such as a physical downlink shared channel (PDSCH)), which may be denoted as x(n). The reader 408 may receive this radio wave, x(n), directly from the RF source 410 via the direct link 420, as well as from the ambient device 405 modulating and reflecting the radio wave to the reader 408 via the backscatter link 415. The signal received at the reader 408 via the direct link 420, indicated by reference number 425, is the product of the radio wave transmitted by the RF source 410, x(n), multiplied by the direct link channel response value, h_{BU}, plus any signal noise. The information bits signal of the ambient device 405 may be denoted as s(n), where s(n)∈{0,1}. Accordingly, the signal received at the reader 408 via the backscatter link 415, indicated by reference number 430, is the product of the signal transmitted by the RF source 410, x(n), multiplied by the first backscatter link channel response value, h_{BD}, the second backscatter link channel response value, h_{DU}, the information bits signal from the ambient device 405, s(n), and a reflection coefficient associated with the ambient device 405 plus any noise.

Thus, the resulting signal received at the reader 408, which is the superposition of the signal received via the direct link 420 and the signal received via the backscatter link 415, may be denoted as y(n). This signal, y(n), is shown by reference number 435. As shown, when s(n)=0 (indicated by reference number 440 in the plot shown at reference number 430), the ambient device 405 may switch off reflection, and thus the reader 408 receives only the direct link 420 signal. When s(n)=1 (indicated by reference number 445 in the plot shown at reference number 430), the ambient device 405 may switch on reflection, and thus the reader 408 receives a superposition of both the direct link 420 signal and the backscatter link 415 signal. To receive the information bits transmitted by the ambient device 405, the reader 408 may first decode x(n) based at least in part on the direct link channel response value of h_{BU}(n) by treating the backscatter link 415 signal as interference. The reader 408 may then detect the existence of the signal component. In some cases, the ambient device 405 may not maintain a state from communication session to communication session except what is stored in the ambient device 405 memory, such as an electronic product code (EPC) associated with ambient device 405 or similar information.

As indicated above, FIG. 4 is provided as an example. Other examples may differ from what is described with respect to FIG. 4.

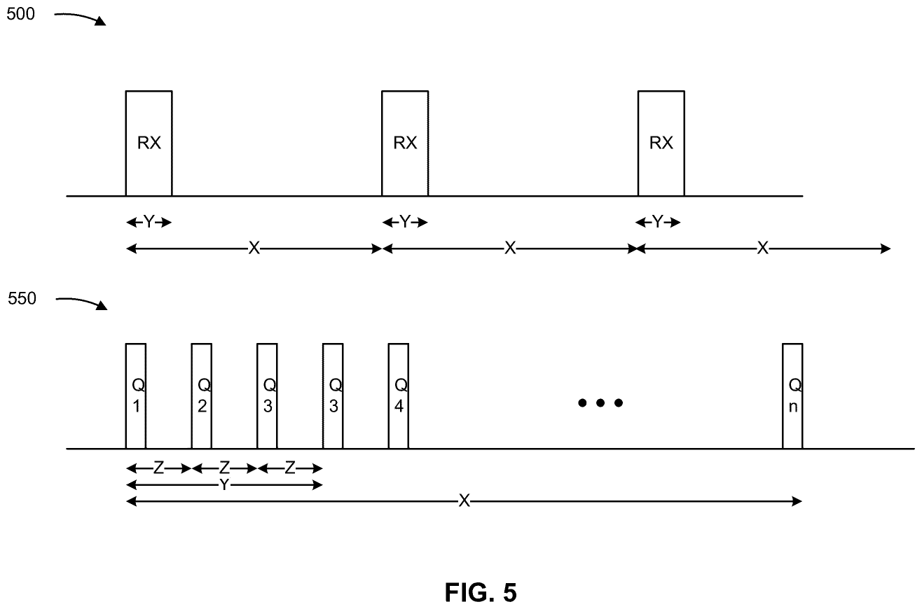

FIG. 5 is a diagram illustrating an example 500/550 of a timing for ambient IoT querying, in accordance with the present disclosure.

As shown in FIG. 5, and by example 500, an ambient IoT device (e.g., a type of UE) may have a set of reception opportunities (RX) associated with a set of wake-up periods. A periodicity for the set of wake-up periods may include a period of time X, in which there is a reception opportunity for a period of time Y. In other words, during the period of time Y, the ambient IoT operates in an awake state to attempt to receive a signal (e.g., a wake-up signal). During a remainder of the period of time X, the ambient IoT device operates in a sleep state, in which the ambient IoT device does not receive a signal (e.g., the wake-up signal). Because different ambient IoT devices may have different timings (e.g., as a result of a lack of synchronization and to reduce contention in environments with hundreds, thousands, or millions of ambient IoT devices), an individual ambient IoT device's reception opportunity may not line up with any single query message or wake-up signal associated therewith.

Accordingly, as shown by example 550, a reader (e.g., a network node) may transmit a set of query messages Q1 through Qn for a single query instance. In this case, a periodicity of the set of query messages is a period of time Z, where Z<Y<X. As an example, for a wake/asleep cycle of X=1 second and a reception opportunity period Y=25 milliseconds (ms), the reader may transmit query messages with a periodicity of Z=10 ms (e.g., resulting in n=100 for the quantity of query messages per query instance). By having a plurality of query messages transmitted during each reception opportunity Y and each wake/asleep cycle X, the reader ensures that each individual ambient IoT device can wake up at a respective time and receive a query message successfully.

As indicated above, FIG. 5 is provided as an example. Other examples may differ from what is described with respect to FIG. 5.

As described above, some ambient IoT devices may be referred to as semi-passive IoT devices, because communication between a reader and the IoT device does not need to be preceded by an energy harvesting waveform. For example, semi-passive IoT devices may include a battery or similar energy source that can power a receiver and/or a logic circuit (either without or in addition to an energy harvesting component). Because of limited battery resources, continuous IoT device monitoring, such as for purposes of receiving long-distance query communications, may result in excessive battery drain at the IoT device. Accordingly, some ambient IoT devices may use a sleep mode to reduce power consumption.

In one use case, ambient IoT devices may be used as tags for inventory tracking, such as within a warehouse or factory environment, and a reader may be used to periodically perform an inventory of items by reading available ambient IoT devices. During inventorying, a reader may query a tag and the tag may report information associated with the tag, such as a device identifier or a position identifier. In another use case, ambient IoT devices may be used as control devices, such as within a grocery store or as a controller of a smart agriculture system. When used as control devices, a reader may query a tag and provide a command, and the tag may transmit an acknowledgment that the command has been received. For example, the reader may transmit a command to change a price on a smart price tag or a command to activate or deactivate a smart agriculture device.

Some operating environments may have thousands or even millions of tags with hundreds or thousands of readers to read the tags. Such use cases may include a reader performing periodic or on-demand inventorying (e.g., tag reading) and may have strict latency requirements (e.g., on an order of one to several seconds) for completing inventorying or command transmission and acknowledgment. However, when a tag enters a sleep mode, as described above, the sleep mode may prevent the tag from receiving an inventory query or a command query. Accordingly, a reader may use unsynchronized duty-cycle based wake-up operation at tags. In this example, the reader may transmit a plurality of queries during an inventory or command instance to allow tags waking-up at different times to receive at least one query. In other words, when a tag is configured to wake up every X seconds and stay awake for a period of Y seconds, the reader may transmit queries with a periodicity of Z seconds (where X>Y>Z), such that each tag will receive at least one query during the awake period of the tag.

However, some reduced capability UEs, such as ambient IoT devices (e.g., tags) may lack control information for completing a query procedure with a reader (e.g., a UE). For example, a low latency requirement associated with a query procedure, such as inventory querying or command querying, may prevent use of channel access procedures that provide an ambient IoT device with resources to receive information from or transmit information to a network node. Accordingly, it is desirable for a query procedure to have a self-contained set of messages that provide the information that a tag uses for completing a query procedure.

Various aspects relate generally to providing query procedures for inventory querying and/or command querying. For example, an ambient IoT device may receive a first message that includes a synchronization signal and a query. The query may include selection criteria identifying a subset of ambient IoT devices to which the first message is applicable, such as ambient IoT devices of a particular type or ambient IoT devices assigned a device identifier or group identifier. The ambient IoT device may transmit a second message, which may include a tag response message indicating that the ambient IoT device received the first message, has synchronized using the synchronization signal of the first message, and is ready to receive an inventory query or a command query. In this case, the ambient IoT device and the reader may communicate using one or more messages (e.g., a third message, a fourth message, a fifth message, or a sixth message, as described in more detail herein) to complete the query procedure. For example, the ambient IoT device may receive a request for tag data (e.g., in an inventory querying procedure) or may receive a command (e.g., in a command querying procedure) and may transmit the tag data or transmit an acknowledgment of the command, respectively.

Particular aspects of the subject matter described in this disclosure can be implemented to realize one or more of the following potential advantages. In some examples, by including a synchronization signal in the first message, the described techniques can be used to enable an ambient IoT device to respond to a query without completing resource intensive channel access procedures. Additionally, or alternatively, by using multiplexing for tag response messages, the ambient IoT device may reduce contention with other ambient IoT devices responding within a dense device environment (e.g., an environment with many devices operating). Similarly, the reader may transmit information identifying a resource allocation with frequency shifting or sequence shifting to avoid contention in communication with the ambient IoT devices. By reducing or avoiding contention, the reader and the ambient IoT device may reduce dropped communications, thereby improving performance, and may reduce network resource utilization associated with retransmitting dropped communications.

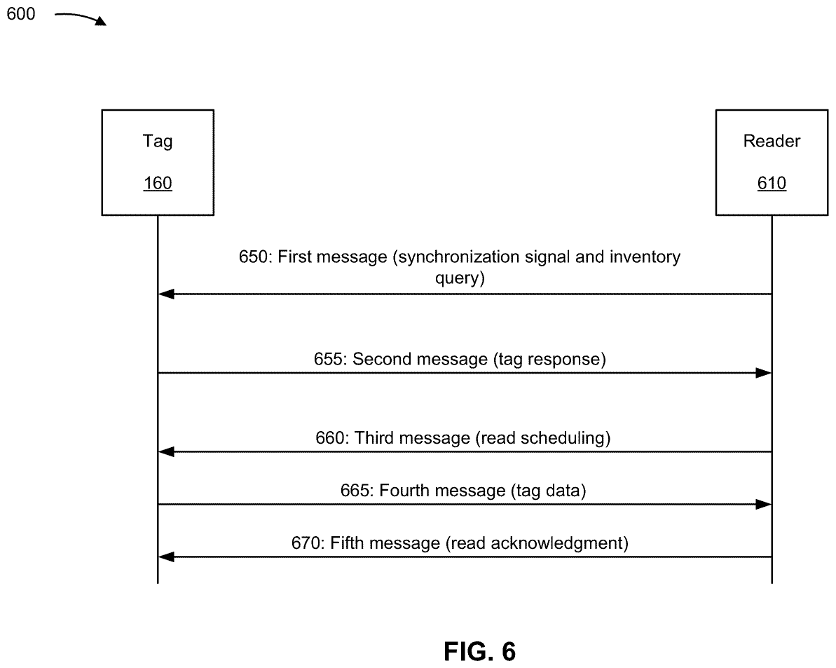

FIG. 6 is a diagram illustrating an example 600 associated with inventory querying, in accordance with the present disclosure. As shown in FIG. 6, example 600 includes communication between a tag 160 and a reader 610 (e.g., a UE 120).

As further shown in FIG. 6, and by reference number 650, the tag 160 may receive a first message. For example, the tag 160 may receive one or more first messages that convey information from the reader 610. In some aspects, the one or more first messages may include a particular type of content. For example, the one or more first messages may include a synchronization signal or a query message (e.g., an inventory query), among other examples. In this case, the synchronization signal may include a preamble message, an aperiodic synchronization signal, or a periodic synchronization signal, among other examples. In some aspects, the query message may include a selection parameter. For example, the query message may include information identifying a selection of a subset of tags to which the query message is directed. In other words, the tag 160 may have an attribute value assigning the tag 160 to a tag group and may receive a query message that includes a parameter identifying the attribute value. In this case, the tag 160 may determine that the tag 160 is a target of the query message based on the query message including the parameter that matches the attribute value of the tag 160. Accordingly, other tags with other attribute values may ignore the query message. Additionally, or alternatively, the query message may include a query identifier, which may be based on an identifier of the reader 610. Additionally, or alternatively, the query message may include inventory round information (e.g., information identifying a query instance for which a plurality of query messages are transmitted) or query instance information (e.g., information identifying the query message within the query instance). In some aspects, the query message may include information identifying resources that the tag 160 is to use to transmit one or more responses to the query message.

Although some aspects are described herein in terms of a set of numbered messages, other arrangements of messages may be used. For example, a message, as described herein, may include a plurality of message parts that are transmitted as a single transmission or as a plurality of transmissions. Additionally, or alternatively, a plurality of messages may be consolidated into a single message.

As further shown in FIG. 6, and by reference number 655, the tag 160 may transmit a second message. For example, the tag 160 may transmit a tag response message indicating receipt of the query message and indicating that the tag 160 matches the query message (e.g., the value of the attribute of the query message matches the parameter in the query message). In this case, the tag 160 may transmit the tag response message in a resource identified by, for example, the reader 610 in the query message.

In some aspects, the tag 160 may be multiplexed with other communications on a channel (e.g., to improve read performance and reduce contention). For example, the tag 160 may backscatter a transmission of the second message with a frequency shift applied to achieve frequency division multiplexing (FDM) with other tags that are transmitting second messages. In this case, other tags may transmit other respective second messages with other frequency shifts applied. Additionally, or alternatively, the tag 160 may backscatter a transmission of the second message with a sequence applied to achieve code division multiplexing (CDM). In this case, the tag 160 may apply a first sequence (e.g., a Hadamard sequence with amplitude-shift keying (ASK) or phase-shift keying (PSK)) and other tags may apply other respective sequences. For example, the tag 160 may apply a sequence 1 with a frequency shift f₁, while one or more other tags may apply a sequence 2 with a frequency shift f₂ or a sequence 1 with a frequency shift f₂. This may improve read performance and may reduce contention by using FDM and/or CDM.

In some aspects, the tag 160 may apply a frequency shift or a sequence based on a function. For example, the tag 160 may use a hash function, with a parameter as an input (e.g., a tag identifier or a query identifier), to select a frequency shift or a sequence for the tag 160. In other words, a tag 160 may select a sequence based on a function, such as a hash function of a tag identifier or query identifier. For example, the tag 160 may use a hash function of the tag identifier or a hash function of both the tag identifier and the query identifier, among other examples. In this case, other tags, using the hash function with other parameters as inputs, may select other frequency shifts or sequences, thereby reducing contention and improving read performance. In some aspects, the tag 160 may select a transmission resource based on a power level. For example, the tag 160 may determine continuous wave (CW) or reference signal (RS) power level quanta and may use the power level quanta to select a frequency shift resource.

In some aspects, the tag 160 may transmit using the same frequency shift or sequence as another tag. For example, when the tag 160 uses a hash function to select a frequency shift and selects the same frequency shift as another tag (e.g., using the hash function to select the frequency shift), a transmission by the tag 160 may collide with another transmission by the other tag. A collision may occur when multiple transmissions are scheduled for the same resource (e.g., using the same frequency shift or sequence, such that the reader 610 may be unable to distinguish, or may have difficulty distinguishing, between the multiple transmissions). In this case, the tag 160 may continue to respond in one or more subsequent queries. For example, when the tag 160 detects a first query Qᵢ and a transmission by the tag 160 collides during the first query Qᵢ, the tag 160 may attempt to retransmit the transmission during a second query Qᵢ₊₁, a third query Qᵢ₊₂, or a fourth query Qᵢ₊₃, among other examples.

In some aspects, the tag 160 may use a hash function with a non-linear dependency on an input parameter to reduce a likelihood of a collision. For example, the tag 160 may use a hash function that has a non-linear dependency on an input query identifier, such as using a hash function associated with a tag identifier). Additionally, or alternatively, the tag 160 may receive information identifying a backoff parameter, which may reduce a contention level. For example, the tag 160 may receive, in the first message, information identifying a backoff parameter for the query, and may use the backoff parameter to configure a transmission to reduce a likelihood of the transmission colliding with other transmissions. In some aspects, the reader 610 may include a backoff parameter in a query message (e.g., the first message or another message) based on a contention level. For example, when a quantity of collisions associated with a first query exceeds a threshold amount, the reader 610 may configure the backoff parameter for a second query, to reduce the quantity of collisions occurring for the second query.

As further shown in FIG. 6, and by reference number 660, the tag 160 may receive a third message. For example, the tag 160 may receive a read scheduling message. In this case, the read scheduling message may include information identifying a set of scheduling resources for a group of tags that are to respond to the query message. In other words, the query message may be directed to a group of tags, which respond, and the reader 610 may transmit scheduling information to the group of tags to indicate resources for providing tag data.

In some aspects, the tag 160 may receive resource allocation information. For example, the tag 160 may receive, from the reader 610, information identifying a resource allocation that is based on a frequency shift or a sequence decoded by the reader 610. In some aspects, the tag 160 may receive information identifying the resource allocation via a particular type of message. For example, the tag 160 may receive downlink control information (DCI) with a format configured for conveying a frequency shift or sequence. In other words, the tag 160 may receive a frequency shift or sequence type of DCI. Additionally, or alternatively, the tag 160 may receive another format of DCI (e.g., a common DCI) that includes information identifying resource allocations. In this case, the common DCI may include a table with a set of frequency shifts and/or sequences and a set of corresponding resource allocations. In other words, the tag 160 may determine that a first resource allocation is assigned for a first frequency shift and a second resource allocation is assigned for a second frequency shift.

As further shown in FIG. 6, and by reference number 665, the tag 160 may transmit a fourth message. For example, the tag 160 may transmit tag information. In this case, the tag information may include a tag identifier (e.g., an identifier of the tag 160) or tag data, among other examples. For example, the tag 160 may store information identifying a state of the tag 160, such as a location of the tag 160 or a battery level of the tag 160, among other examples, and may transmit tag data to indicate the state of the tag 160. In some aspects, the tag 160 may use backscattering to transmit the tag information. For example, the tag 160 may backscatter a transmission from the reader 610 to transmit tag information, such as for an ambient IoT device type 1 or type 2A. Additional details regarding ambient IoT device types are described in 3GPP Technical Report (TR) 38.848, Version 18.0.0. Additionally, or alternatively, the tag 160 may use active transmission to transmit the tag information (e.g., using battery resources of the tag 160), such as for an ambient IoT device type 2B.

As further shown in FIG. 6, and by reference number 670, the tag 160 may receive a fifth message. For example, the tag 160 may receive an acknowledgment message from the reader 610. In this case, the acknowledgment message may indicate successful reception of the tag information by the reader 610. Alternatively, when the tag 160 does not receive the acknowledgment message from the reader 610, the tag 160 may retransmit the tag information or perform another action. In some aspects, the reader 610 may include information identifying one or more tags for which the acknowledgment message applies. For example, the reader 610 may include information identifying a list of frequency shifts, sequences, resource allocations, or tag identifiers for tags that are being acknowledged by the acknowledgment message. In this case, the tag 160 may parse the acknowledgment message to determine whether the reader 610 has successfully received the tag information from the tag 160. In this case, when the reader 610 has not acknowledged the tag 160 (e.g., the acknowledgment message does not include a frequency shift used by the tag 160), the tag 160 may determine that a collision (or other communication interruption) has occurred, and may determine to retransmit tag information (e.g., as a response to another query).

As indicated above, FIG. 6 is provided as an example. Other examples may differ from what is described with respect to FIG. 6.

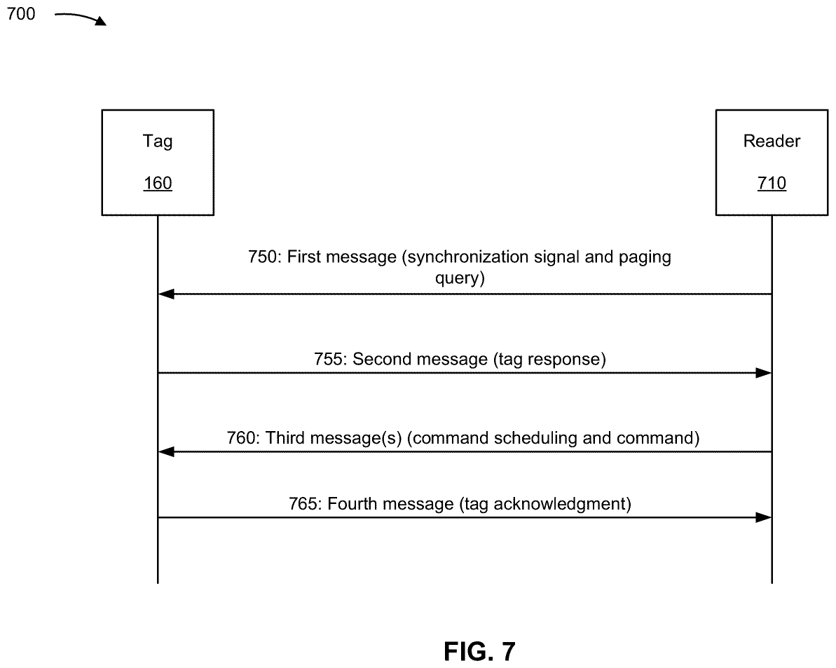

FIG. 7 is a diagram illustrating an example 700 associated with command querying, in accordance with the present disclosure. As shown in FIG. 7, example 700 includes communication between a tag 160 and a reader 710.

As further shown in FIG. 7, and by reference number 750, the tag 160 may receive a first message. For example, the tag 160 may receive one or more first messages from the reader 710. In this case, the one or more first messages may include a synchronization signal or a query message, among other examples. In some aspects, the query message may include paging list information. For example, the tag 160 may include paging list information, which may include information identifying one or more tags 160 that are a target for a command query. Additionally, or alternatively, the tag 160 may include paging list information that includes a resource allocation. For example, the tag 160 may determine a resource allocation based on an explicit resource allocation indicator or mapping included in the paging list information. Additionally, or alternatively, the tag 160 may determine one or more resource parameters, such as a sequence associated with a resource mapping. For example, the tag 160 may determine a Hadamard sequence associated with resolving a contention for a resource.

As further shown in FIG. 7, and by reference number 755, the tag 160 may transmit a second message. For example, the tag 160 may transmit, to the reader 710, a tag response indicating receipt of the command query. As described above, the tag response may include a backscatter transmission with a frequency shift or sequence applied to reduce a contention level and/or a likelihood of a collision. For example, as described above, the tag 160 may determine a frequency shift or sequence to apply using a hash function, and may transmit the second message using the frequency shift or with the sequence being applied. In some aspects, when there is a collision associated with the second message (or another message), the tag 160 may retransmit the second message (or another message) using a retransmission resource or as a response to another query instance.

As further shown in FIG. 7, and by reference number 760, the tag 160 may receive a third message. For example, the tag 160 may receive scheduling information identifying scheduling for the reader 710 to transmit a command. Additionally, or alternatively, the tag 160 may receive the command (e.g., in accordance with the scheduling). In some aspects, the third message may include information identifying one or more tags to which the third message applies. For example, the tag 160 may parse the third message to determine a resource in which to receive a command, whether the command is applicable to the tag 160, and/or an identifier of the command. In some aspects, the command may include an indicator value. For example, the reader 710 may transmit an indicator value and the tag 160 may map the indicator value to a table identifying a command corresponding to the indicator value. Additionally, or alternatively, the reader 710 may transmit an explicit command. For example, the reader 710 may transmit a command message with a particular value that the tag 160 is to use as a parameter (e.g., an explicit transmit power value or transmit power offset value) or with an information element set to a value indicating a setting for the tag 160 (e.g., whether a function is on or off).

As further shown in FIG. 7, and by reference number 765, the tag 160 may transmit a fourth message. For example, the tag 160 may transmit, to the reader 710, an acknowledgment of the command. In this case, the acknowledgment may include information indicating whether the command was successfully executed and/or another type of result of the command being executed. In some aspects, the acknowledgment may include an identifier of the tag 160. For example, the tag 160 may include an explicit identifier of the tag 160 (e.g., an information element or parameter that identifiers the tag 160) or an implicit identifier of the tag 160 (e.g., the acknowledgment may be transmitted with a frequency shift or sequence that corresponds to the tag 160).

As indicated above, FIG. 7 is provided as an example. Other examples may differ from what is described with respect to FIG. 7.

FIG. 8 is a diagram illustrating an example process 800 performed, for example, at an ambient IoT device or an apparatus of an ambient IoT device, in accordance with the present disclosure. Example process 800 is an example where the apparatus or the ambient IoT device (e.g., tag 160) performs operations associated with ambient IoT querying.

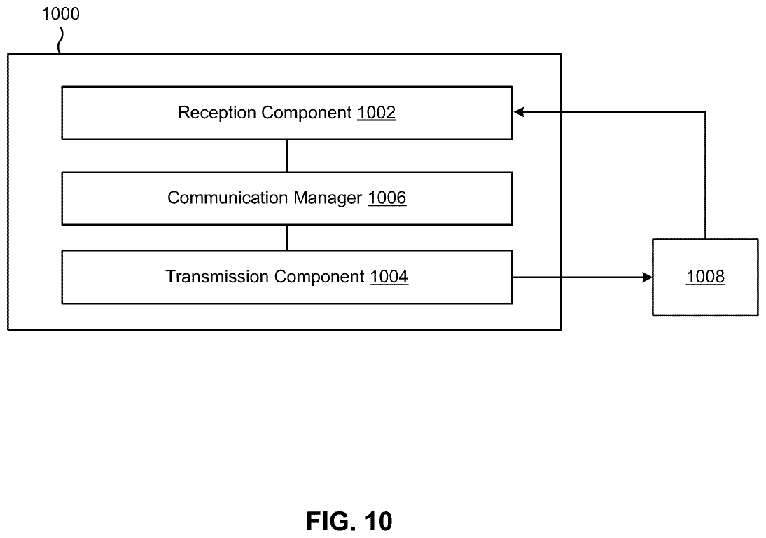

As shown in FIG. 8, in some aspects, process 800 may include receiving, from a reader, one or more first messages during a wakeup period, wherein a first message, of the one or more first messages, includes a plurality of elements, wherein the plurality of elements includes a synchronization signal and an identifier (block 810). For example, the ambient IoT device (e.g., using reception component 1002 and/or communication manager 1006, depicted in FIG. 10) may receive, from a reader, one or more first messages during a wakeup period, wherein a first message, of the one or more first messages, includes a plurality of elements, wherein the plurality of elements includes a synchronization signal and an identifier, as described above. In some aspects, a first message, of the one or more first messages, includes a plurality of elements, wherein the plurality of elements includes a synchronization signal and an identifier.

As further shown in FIG. 8, in some aspects, process 800 may include transmitting, to the reader, a second message as a response to the one or more first messages (block 820). For example, the ambient IoT device (e.g., using transmission component 1004 and/or communication manager 1006, depicted in FIG. 10) may transmit, to the reader, a second message as a response to the one or more first messages, as described above.

Process 800 may include additional aspects, such as any single aspect or any combination of aspects described below and/or in connection with one or more other processes described elsewhere herein.

In a first aspect, the first message includes a query message and the second message includes a query response message, or the first message includes a paging message and the second message includes a paging response message.

In a second aspect, alone or in combination with the first aspect, process 800 includes receiving a third message as a response to the second message.

In a third aspect, alone or in combination with one or more of the first and second aspects, the third message includes one or more identifiers associated with the second message.

In a fourth aspect, alone or in combination with one or more of the first through third aspects, the third message includes a query response acknowledgment message or the third message includes a command message.

In a fifth aspect, alone or in combination with one or more of the first through fourth aspects, process 800 includes transmitting a fourth message as a response to the third message.

In a sixth aspect, alone or in combination with one or more of the first through fifth aspects, the fourth message includes a command acknowledgment message, or the fourth message includes a device identifier.

In a seventh aspect, alone or in combination with one or more of the first through sixth aspects, the one or more first messages are transmitted using frequency division multiplexing or code division multiplexing, and the second message is associated with a frequency shift, in connection with frequency division multiplexing, or a sequence modulation, in connection with code division multiplexing.

In an eighth aspect, alone or in combination with one or more of the first through seventh aspects, the frequency shift is associated with a backscattering of one or more communications between the ambient IoT device and the reader.

In a ninth aspect, alone or in combination with one or more of the first through eighth aspects, the sequence modulation is based on a hash algorithm using a tag identifier associated with the ambient IoT device or a first message identifier associated with the one or more first messages.

In a tenth aspect, alone or in combination with one or more of the first through ninth aspects, the frequency shift is based on a received power.

In an eleventh aspect, alone or in combination with one or more of the first through tenth aspects, process 800 includes receiving, from the reader, a resource allocation associated with the second message.

In a twelfth aspect, alone or in combination with one or more of the first through eleventh aspects, the resource allocation is associated with a frequency shift or a sequence modulation.

In a thirteenth aspect, alone or in combination with one or more of the first through twelfth aspects, a format of the resource allocation corresponds to a group random access common downlink control information message.

In a fourteenth aspect, alone or in combination with one or more of the first through thirteenth aspects, transmitting the second message comprises transmitting a plurality of second messages in a plurality of second message opportunities.

In a fifteenth aspect, alone or in combination with one or more of the first through fourteenth aspects, a hash, in connection with the second message, has a non-linear dependency on a first message identifier of the one or more first messages.

In a sixteenth aspect, alone or in combination with one or more of the first through fifteenth aspects, the one or more first messages includes information identifying a backoff parameter relating to a contention level in a channel.

In a seventeenth aspect, alone or in combination with one or more of the first through sixteenth aspects, the one or more first messages is associated with a command to remove the ambient IoT device from a paging list.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a reader or an apparatus of a reader, in accordance with the present disclosure. Example process 900 is an example where the apparatus or the reader (e.g., UE 120) performs operations associated with ambient IoT querying.

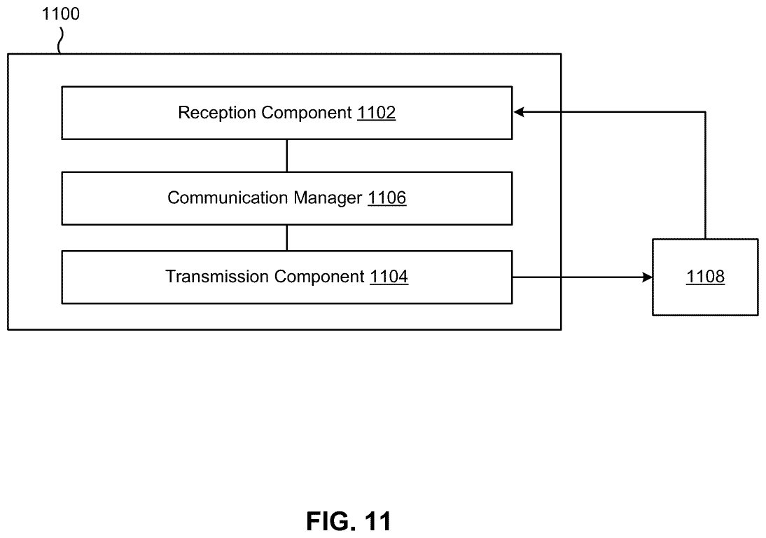

As shown in FIG. 9, in some aspects, process 900 may include transmitting, to an ambient Internet-of-Things (IoT) device, one or more first messages during a wakeup period, wherein a first message, of the one or more first messages, includes a plurality of elements, wherein the plurality of elements includes a synchronization signal and an identifier (block 910). For example, the reader (e.g., using transmission component 1104 and/or communication manager 1106, depicted in FIG. 11) may transmit, to an ambient IoT device, one or more first messages during a wakeup period, wherein a first message, of the one or more first messages, includes a plurality of elements, wherein the plurality of elements includes a synchronization signal and an identifier, as described above. In some aspects, a first message, of the one or more first messages, includes a plurality of elements, wherein the plurality of elements includes a synchronization signal and an identifier.

As further shown in FIG. 9, in some aspects, process 900 may include receiving, from the ambient IoT device, a second message as a response to the one or more first messages (block 920). For example, the reader (e.g., using reception component 1102 and/or communication manager 1106, depicted in FIG. 11) may receive, from the ambient IoT device, a second message as a response to the one or more first messages, as described above.

Process 900 may include additional aspects, such as any single aspect or any combination of aspects described below and/or in connection with one or more other processes described elsewhere herein.

In a first aspect, the first message includes a query message and the second message includes a query response message, or the first message includes a paging message and the second message includes a paging response message.

In a second aspect, alone or in combination with the first aspect, process 900 includes transmitting a third message as a response to the second message.

In a third aspect, alone or in combination with one or more of the first and second aspects, the third message includes one or more identifiers associated with the second message.

In a fourth aspect, alone or in combination with one or more of the first through third aspects, the third message includes a query response acknowledgment message or the third message includes a command message.

In a fifth aspect, alone or in combination with one or more of the first through fourth aspects, process 900 includes receiving a fourth message as a response to the third message.

In a sixth aspect, alone or in combination with one or more of the first through fifth aspects, the fourth message includes a command acknowledgment message, or the fourth message includes a device identifier.

In a seventh aspect, alone or in combination with one or more of the first through sixth aspects, the one or more first messages are transmitted using frequency division multiplexing or code division multiplexing, and the second message is associated with a frequency shift, in connection with frequency division multiplexing, or a sequence modulation, in connection with code division multiplexing.

In an eighth aspect, alone or in combination with one or more of the first through seventh aspects, the frequency shift is associated with a backscattering of one or more communications between the ambient IoT device and the reader.

In a ninth aspect, alone or in combination with one or more of the first through eighth aspects, the sequence modulation is based on a hash algorithm using a tag identifier associated with the ambient IoT device or a first message identifier associated with the one or more first messages.

In a tenth aspect, alone or in combination with one or more of the first through ninth aspects, the frequency shift is based on a received power.

In an eleventh aspect, alone or in combination with one or more of the first through tenth aspects, process 900 includes transmitting, to the ambient IoT device, a resource allocation associated with the second message.

In a twelfth aspect, alone or in combination with one or more of the first through eleventh aspects, the resource allocation is associated with a frequency shift or a sequence modulation.

In a thirteenth aspect, alone or in combination with one or more of the first through twelfth aspects, a format of the resource allocation corresponds to a group random access common downlink control information message.

In a fourteenth aspect, alone or in combination with one or more of the first through thirteenth aspects, receiving the second message comprises receiving a plurality of second messages in a plurality of second message opportunities.

In a fifteenth aspect, alone or in combination with one or more of the first through fourteenth aspects, a hash, in connection with the second message, has a non-linear dependency on a first message identifier of the one or more first messages.

In a sixteenth aspect, alone or in combination with one or more of the first through fifteenth aspects, the one or more first messages includes information identifying a backoff parameter relating to a contention level in a channel.

In a seventeenth aspect, alone or in combination with one or more of the first through sixteenth aspects, the one or more first messages are associated with a command to remove the ambient IoT device from a paging list.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be an ambient IoT device (e.g., a tag 160), or an ambient IoT device may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 162 described in connection with FIG. 1. As shown, the apparatus 1000 may communicate with another apparatus 1008, such as a UE (such as a reader) or a network node (such as a CU, a DU, an RU, or a base station), using the reception component 1002 and the transmission component 1004.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the ambient IoT device described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the ambient IoT device described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the ambient IoT device described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a reader, one or more first messages during a wakeup period, wherein a first message, of the one or more first messages, includes a plurality of elements, and wherein the plurality of elements includes a synchronization signal and an identifier. The transmission component 1004 may transmit, to the reader, a second message as a response to the one or more first messages. The reception component 1002 may receive a third message as a response to the second message. The transmission component 1004 may transmit a fourth message as a response to the third message. The reception component 1002 may receive, from the reader, a resource allocation associated with the second message.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a reader (e.g., a UE 120), or a reader may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as an ambient IoT device (e.g., a tag), a UE, or a network node (such as a CU, a DU, an RU, or a base station), using the reception component 1102 and the transmission component 1104.

In some aspects, the apparatus 1100 may be configured to perform one or more operations described herein in connection with FIGS. 6-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the reader described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the reader described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the reader described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to an ambient IoT device, one or more first messages during a wakeup period, wherein a first message, of the one or more first messages, includes a plurality of elements, and wherein the plurality of elements includes a synchronization signal and an identifier. The reception component 1102 may receive, from the ambient IoT device, a second message as a response to the one or more first messages. The transmission component 1104 may transmit a third message as a response to the second message. The reception component 1102 may receive a fourth message as a response to the third message. The transmission component 1104 may transmit, to the ambient IoT device, a resource allocation associated with the second message.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by an ambient Internet-of-Things (IoT) device, comprising: receiving, from a reader, one or more first messages during a wakeup period, wherein a first message, of the one or more first messages, includes a plurality of elements, wherein the plurality of elements includes a synchronization signal and an identifier; and transmitting, to the reader, a second message as a response to the one or more first messages.

Aspect 2: The method of Aspect 1, wherein the first message includes a query message and the second message includes a query response message, or wherein the first message includes a paging message and the second message includes a paging response message.

Aspect 3: The method of any of Aspects 1-2, further comprising: receiving a third message as a response to the second message.

Aspect 4: The method of Aspect 3, wherein the third message includes one or more identifiers associated with the second message.

Aspect 5: The method of Aspect 3, wherein the third message includes a query response acknowledgment message or the third message includes a command message.

Aspect 6: The method of Aspect 3, further comprising: transmitting a fourth message as a response to the third message.

Aspect 7: The method of Aspect 6, wherein the fourth message includes a command acknowledgment message, or wherein the fourth message includes a device identifier.

Aspect 8: The method of any of Aspects 1-7, wherein the one or more first messages are transmitted using frequency division multiplexing or code division multiplexing, and wherein the second message is associated with a frequency shift, in connection with frequency division multiplexing, or a sequence modulation, in connection with code division multiplexing.

Aspect 9: The method of Aspect 8, wherein the frequency shift is associated with a backscattering of one or more communications between the ambient IoT device and the reader.

Aspect 10: The method of Aspect 8, wherein the sequence modulation is based on a hash algorithm using a tag identifier associated with the ambient IoT device or a first message identifier associated with the one or more first messages.

Aspect 11: The method of Aspect 8, wherein the frequency shift is based on a received power.

Aspect 12: The method of any of Aspects 1-11, further comprising: receiving, from the reader, a resource allocation associated with the second message.

Aspect 13: The method of Aspect 12, wherein the resource allocation is associated with a frequency shift or a sequence modulation.

Aspect 14: The method of Aspect 13, wherein a format of the resource allocation corresponds to a group random access common downlink control information message.

Aspect 15: The method of any of Aspects 1-14, wherein transmitting the second message comprises: transmitting a plurality of second messages in a plurality of second message opportunities.

Aspect 16: The method of any of Aspects 1-15, wherein a hash, in connection with the second message, has a non-linear dependency on a first message identifier of the one or more first messages.

Aspect 17: The method of any of Aspects 1-16, wherein the one or more first messages includes information identifying a backoff parameter relating to a contention level in a channel.

Aspect 18: The method of any of Aspects 1-17, wherein the one or more first messages is associated with a command to remove the ambient IoT device from a paging list.

Aspect 19: A method of wireless communication performed by a reader, comprising: transmitting, to an ambient Internet-of-Things (IoT) device, one or more first messages during a wakeup period, wherein a first message, of the one or more first messages, includes a plurality of elements, wherein the plurality of elements includes a synchronization signal and an identifier; and receiving, from the ambient IoT device, a second message as a response to the one or more first messages.

Aspect 20: The method of Aspect 19, wherein the first message includes a query message and the second message includes a query response message, or wherein the first message includes a paging message and the second message includes a paging response message.

Aspect 21: The method of any of Aspects 19-20, further comprising: transmitting a third message as a response to the second message.

Aspect 22: The method of Aspect 21, wherein the third message includes one or more identifiers associated with the second message.

Aspect 23: The method of Aspect 21, wherein the third message includes a query response acknowledgment message or the third message includes a command message.

Aspect 24: The method of Aspect 21, further comprising: receiving a fourth message as a response to the third message.

Aspect 25: The method of Aspect 24, wherein the fourth message includes a command acknowledgment message, or wherein the fourth message includes a device identifier.

Aspect 26: The method of any of Aspects 19-25, wherein the one or more first messages are transmitted using frequency division multiplexing or code division multiplexing, and wherein the second message is associated with a frequency shift, in connection with frequency division multiplexing, or a sequence modulation, in connection with code division multiplexing.

Aspect 27: The method of Aspect 26, wherein the frequency shift is associated with a backscattering of one or more communications between the ambient IoT device and the reader.

Aspect 28: The method of Aspect 26, wherein the sequence modulation is based on a hash algorithm using a tag identifier associated with the ambient IoT device or a first message identifier associated with the one or more first messages.

Aspect 29: The method of Aspect 26, wherein the frequency shift is based on a received power.

Aspect 30: The method of any of Aspects 19-29, further comprising: transmitting, to the ambient IoT device, a resource allocation associated with the second message.

Aspect 31: The method of Aspect 30, wherein the resource allocation is associated with a frequency shift or a sequence modulation.

Aspect 32: The method of Aspect 31, wherein a format of the resource allocation corresponds to a group random access common downlink control information message.

Aspect 33: The method of any of Aspects 19-32, wherein receiving the second message comprises: receiving a plurality of second messages in a plurality of second message opportunities.

Aspect 34: The method of any of Aspects 19-33, wherein a hash, in connection with the second message, has a non-linear dependency on a first message identifier of the one or more first messages.

Aspect 35: The method of any of Aspects 19-34, wherein the one or more first messages includes information identifying a backoff parameter relating to a contention level in a channel.

Aspect 36: The method of any of Aspects 19-35, wherein the one or more first messages is associated with a command to remove the ambient IoT device from a paging list.

Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-36.

Aspect 38: An apparatus for wireless communication at a device, the apparatus comprising one or more memories and one or more processors coupled to the one or more memories, the one or more processors configured to cause the device to perform the method of one or more of Aspects 1-36.

Aspect 39: An apparatus for wireless communication, the apparatus comprising at least one means for performing the method of one or more of Aspects 1-36.

Aspect 40: A non-transitory computer-readable medium storing code for wireless communication, the code comprising instructions executable by one or more processors to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

Aspect 42: A device for wireless communication, the device comprising a processing system that includes one or more processors and one or more memories coupled with the one or more processors, the processing system configured to cause the device to perform the method of one or more of Aspects 1-36.

Aspect 43: An apparatus for wireless communication at a device, the apparatus comprising one or more memories and one or more processors coupled to the one or more memories, the one or more processors individually or collectively configured to cause the device to perform the method of one or more of Aspects 1-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An ambient Internet-of-Things (IoT) device for wireless communication, comprising:
one or more memories; and
one or more processors, coupled to the one or more memories, configured to cause the ambient IoT device to:
receive, from a reader, one or more first messages during a wakeup period,
wherein a first message, of the one or more first messages, includes a plurality of elements, wherein the plurality of elements includes a synchronization signal and an identifier; and
transmit, to the reader, a second message as a response to the one or more first messages.

2. The ambient IoT device of claim 1, wherein the first message includes a query message and the second message includes a query response message, or
wherein the first message includes a paging message and the second message includes a paging response message.

3. The ambient IoT device of claim 1, wherein the one or more processors are further configured to cause the ambient IoT device to:
receive a third message as a response to the second message.

4. The ambient IoT device of claim 3, wherein the third message includes one or more identifiers associated with the second message.

5. The ambient IoT device of claim 3, wherein the third message includes a read scheduling message or the third message includes a command message.

6. The ambient IoT device of claim 3, wherein the one or more processors are further configured to cause the ambient IoT device to:
transmit a fourth message as a response to the third message.

7. The ambient IoT device of claim 6, wherein the fourth message includes a command acknowledgment message, or
wherein the fourth message includes a device identifier.

8. The ambient IoT device of claim 1, wherein the one or more first messages are transmitted using frequency division multiplexing or code division multiplexing, and
wherein the second message is associated with a frequency shift, in connection with frequency division multiplexing, or a sequence modulation, in connection with code division multiplexing.

9. The ambient IoT device of claim 8, wherein the frequency shift is associated with a backscattering of one or more communications between the ambient IoT device and the reader.

10. The ambient IoT device of claim 8, wherein the sequence modulation is based on a hash algorithm using a tag identifier associated with the ambient IoT device or a first message identifier associated with the one or more first messages.

11. The ambient IoT device of claim 8, wherein the frequency shift is based on a received power.

12. The ambient IoT device of claim 1, wherein the one or more processors are further configured to cause the ambient IoT device to:
receive, from the reader, a resource allocation associated with the second message.

13. The ambient IoT device of claim 12, wherein the resource allocation is associated with a frequency shift or a sequence modulation.

14. The ambient IoT device of claim 13, wherein a format of the resource allocation corresponds to a group random access common downlink control information message.

15. The ambient IoT device of claim 1, wherein the one or more processors, to cause the ambient IoT device to transmit the second message, are configured to cause the ambient IoT device to:
transmit a plurality of second messages in a plurality of second message opportunities.

16. The ambient IoT device of claim 1, wherein a hash, in connection with the second message, has a non-linear dependency on a first message identifier of the one or more first messages.

17. The ambient IoT device of claim 1, wherein the one or more first messages includes information identifying a backoff parameter relating to a contention level in a channel.

18. The ambient IoT device of claim 1, wherein the one or more first messages is associated with a command to remove the ambient IoT device from a paging list.

19. A reader for wireless communication, comprising:
one or more memories; and
one or more processors, coupled to the one or more memories, configured to cause the reader to:
transmit, to an ambient Internet-of-Things (IoT) device, one or more first messages during a wakeup period,
wherein a first message, of the one or more first messages, includes a plurality of elements, wherein the plurality of elements includes a synchronization signal and an identifier; and
receive, from the ambient IoT device, a second message as a response to the one or more first messages.

20. A method of wireless communication performed by an ambient Internet-of-Things (IoT) device, comprising:
receiving, from a reader, one or more first messages during a wakeup period,
wherein a first message, of the one or more first messages, includes a plurality of elements, wherein the plurality of elements includes a synchronization signal and an identifier; and
transmitting, to the reader, a second message as a response to the one or more first messages.
